(19) United States
(12) Patent Application Publication
(10) Pub. No.: US 2004/0189849 A1
(43) Pub. Date: Sep. 30, 2004

(54) Panoramic sequence guide

(76) Inventor: Gregory V. Hofer, Loveland, CO (US)

Correspondence Address: HEWLETT-PACKARD DEVELOPMENT COMPANY, Intellectual Property Administration, P O Box 272400, Fort Collins, CO, 80527-2400, US

(21) Appl. No.: 10/403,622

(22) Filed: Mar. 31, 2003

(51) Int. Cl. H04N 5/222; H04N 7/00

(52) U.S. Cl. 348/333.03; 348/333.02; 348/36

(57) ABSTRACT

Disclosed is a panoramic sequence guide that can be used to guide a user in composing and capturing images to be used to create a composite panoramic image. In use, the guide tracks a viewed scene, determines the proper position of a composition guide relative to the viewed scene, and displays a composition guide on a live-view screen that provides an indication of what portion of the viewed scene is to be captured. The displayed composition guide is fixed to the viewed scene such that the guide moves with the viewed scene in the screen.

### BACKGROUND

Ever since advanced photo system (APS) cameras came into common use with consumers, panoramic picture taking has been popular. Panoramic images are those in which one dimension (e.g., width) of the image is substantially larger than the other dimension (e.g., height). More recently, digital cameras appear to have surpassed APS cameras in popularity with the consumer. Digital cameras can also be used to generate panoramic images. Such images can be created, for example, by digitally capturing, and later joining together, several sequential images. Therefore, the user can, for instance, capture a first image, pan the camera to the right until a portion of the captured scene is viewable through the viewfinder or back panel display, capture the next image, and so on until the full scene has been captured with a series of images.

Although the above-described method for creating panoramic images with a digital camera is viable, it does not always provide good results. For instance, if the user does not provide enough overlap from captured image to captured image, portions of the total scene can be missing from the final generated panoramic image. Furthermore, unless the camera is held perfectly level from shot to shot, a crooked-looking panoramic image can result and/or the joints or “seams” of the individually captured images may be obvious.

To prevent such problems from occurring, several digital cameras now may,be used in a panoramic mode in which a user interface is provided that aids the user in composing the various sequential shots. One such user interface comprises a vertical line that is shown in the live-view screen (e.g., viewfinder or back panel display) after a first image is captured in panoramic mode. Typically, the line is positioned approximately one-third of the screen width from the edge (e.g., left edge) of the screen to serve as a guide for the user to compose the next shot. In particular, the user may align the vertical line with the edge (e.g., right edge) of the scene that was captured in the first image. If the user captures the second image when the camera is so aligned, there will presumably be adequate overlap between the two images (e.g., approximately ⅓ of the image width) to later join them together using an appropriate “stitching” program.

In a more sophisticated method, a ghost image of the previously captured image is displayed in the live-view screen when the camera is used in panoramic mode. Only part of the previously captured image is displayed in that the image is offset from the center of the screen (e.g., only a third of the image is displayed), and is a “ghost” image in that it is transparent such that the real time captured scene is visible through the displayed image. With the provision of the ghost image, the user may align the camera such that the ghost image overlaps the viewed scene in registration with the objects in the real time scene. Once the camera is aligned in this manner, the next image may be captured and, due to the position of the ghost image on the live-view screen, there will be sufficient overlap to generate a panoramic image.

Although the above-described user interfaces and methods provide some guidance to the user in composing and capturing images for the purpose of creating panoramic images, other perhaps more intuitive user interfaces and methods would be desirable.

### SUMMARY

Disclosed is a panoramic sequence guide that can be used to guide a user in composing and capturing images to be used to create a composite panoramic image. In use, the guide tracks a viewed scene, determines the proper position of a composition guide relative to the viewed scene, and displays a composition guide on a live-view screen that provides an indication of what portion of the viewed scene is to be captured. The displayed composition guide is fixed to the viewed scene such that the guide moves with the viewed scene in the screen.

### BRIEF DESCRIPTION OF THE DRAWINGS

FIG. 1 is a front perspective view of an embodiment of a camera that incorporates an intuitive panoramic sequence guide.

FIG. 2 is a rear view of the camera of FIG. 1.

FIG. 3 is an embodiment of a schematic representation of the camera shown in FIGS. 1 and 2.

FIG. 4 is a schematic of a first example subject that is to be captured and used as the subject of a panoramic image.

FIGS. 5A-5E are schematic representations of a live-view screen of the camera of FIGS. 1-3, depicting scenes and user guides viewed in the first embodiment of a method for guiding a user in composing and capturing images for the purpose of creating a panoramic image.

FIG. 6 is a schematic representation of a live-view screen of the camera of FIG. 1-3, depicting scenes and user guides viewed according to the method depicted in FIGS. 5A-5E in the context of creating a panoramic image of a vertical subject.

FIGS. 7A-7D are schematic representations of a live-view screen of the camera of FIGS. 1-3, depicting scenes and user guides viewed in a second of a method for guiding a user in composing and capturing images for the purpose of creating a panoramic image.

FIG. 8 is a schematic view of a second subject that is to be captured and used as the subject of a panoramic image.

FIGS. 9A-9F are schematic representations of a live-view screen of the camera of FIGS. 1-3, depicting scenes and user guides in a third embodiment of a method for guiding a user in composing and capturing images for the purpose of creating a panoramic image.

FIG. 10 is a schematic representation depicting the manner in which misalignment of the camera relative to a viewed scene or a previously identified scene composition can be corrected using the method for guiding of FIGS. 9A-9F.

FIG. 11 is a flow diagram that illustrates an embodiment of operation of a panoramic sequence guide system and a dynamic tracking system in aiding a user in composing and capturing images that are to be joined to create a panoramic image.

### DETAILED DESCRIPTION

Disclosed are panoramic sequence guides that aid users in capturing images for the purpose of creating panoramic images. More specifically, disclosed are user interfaces that, when integrated into a live-view screen of a camera, can be used to more correctly compose and align sequential shots that are to be captured and joined to form a high aspect ratio panoramic image.

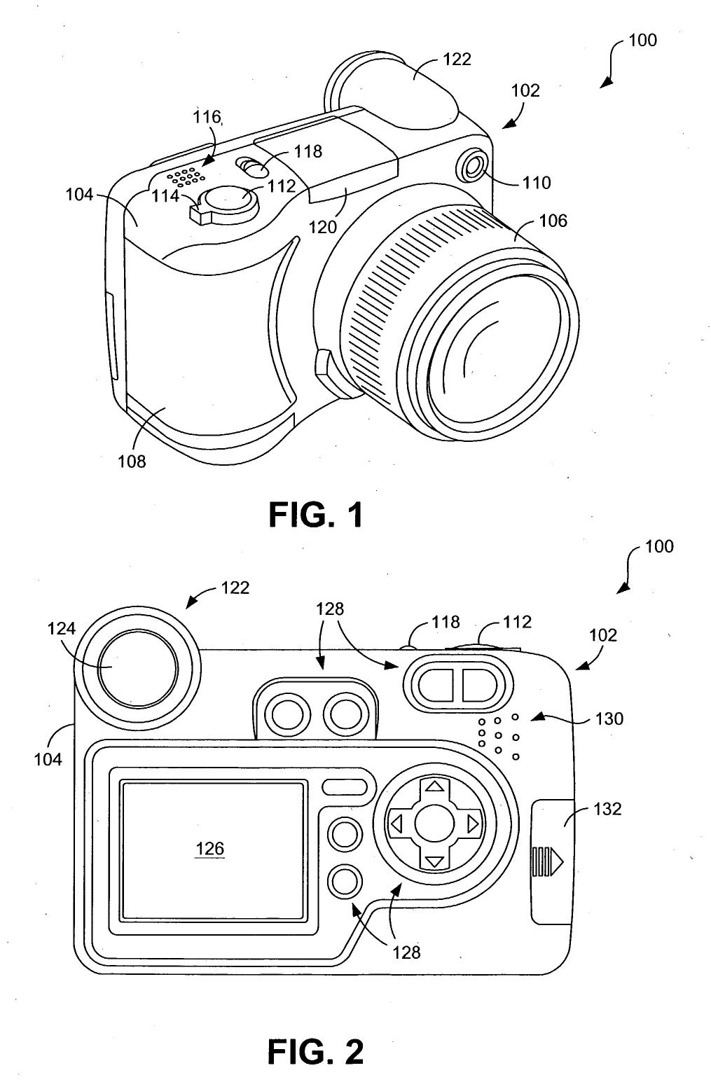

Referring to the drawings, in which like numerals indicate corresponding parts throughout the several views, FIGS. 1 and 2 illustrate an embodiment of a camera 100 that incorporates a panoramic sequence guide system. As indicated in these figures, the camera 100 can comprise a digital still camera. Although a digital still camera implementation is shown in the figures and described herein, it is to be understood that the systems and methods disclosed herein may also be implemented in film and/or video cameras, if desired.

As indicated in FIG. 1, the camera 100 includes a body 102 that is encapsulated by an outer housing 104. The camera 100 further includes a lens barrel 106 that, by way of example, houses a zoom lens system. Incorporated into the front portion of the camera body 102 is a grip 108 that is used to grasp the camera 100 and a window 110 that can be used to collect visual information used to set the camera focus.

The top portion of the camera 100 is provided with a shutter-release button 112 that is used to open the camera shutter (not visible in FIG. 1). Surrounding the shutter-release button 112 is a ring control 114 that is used to set the camera mode. Adjacent the shutter-release button 112 is a microphone 116 that may be used to capture audio, if desired. Next to the microphone 116 is a switch 118 that is used to control operation of a pop-up flash 122 (shown in the retracted position) that can be used to illuminate objects in low light conditions.

With particular reference to FIG. 2, which shows the rear of the camera 100, further provided on the camera body 102 is a viewfinder 122. In a preferred arrangement, the viewfinder 122 comprises an electronic viewfinder (EVF) that incorporates a microdisplay (not visible in FIG. 2) that can be used to compose images and upon which captured images are presented to the user. These images may be viewed by looking through a view window 124 of the viewfinder 122 that typically comprises a magnifying lens or lens system. Below the viewfinder 122 is a flat panel display 126 that, like the microdisplay, may be used to compose shots and review captured images. By way of example, the display 126 comprises a liquid crystal display (LCD). In any case, the display 126, as well as the microdisplay or other screen presented in the viewfinder 122, may be designated a live-view screen in that real time images can be presented to the user with the screen.

Various control buttons 128 are also provided on the rear of the camera body 102. These buttons 128 can be used to, for instance, change camera settings, navigate control menus presented in the display 126, and scroll through images shown in the display or the viewfinder 122. The rear of the camera body 102 further includes a speaker 130 that is used to present audible information to the user (e.g., beeps and recorded sound) and a compartment 132 that is used to house a memory card.

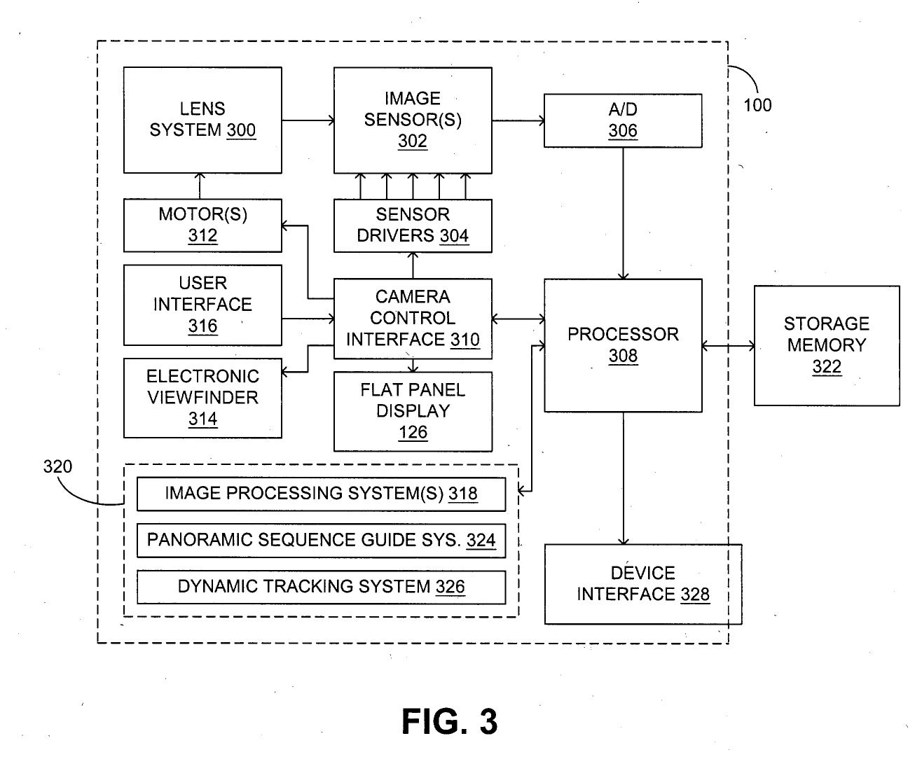

FIG. 3 provides an example architecture for the camera 100. As indicated in this figure, the camera 100 includes a lens system 300 that conveys images of viewed scenes to one or more image sensors 302. By way of example, the image sensors 302 comprise charge-coupled devices (CCDs) that are driven by one or more sensor drivers 304. The analog image signals captured by the sensors 302 are then provided to an analog-to-digital (A/D) converter 306 for conversion into binary code that can be processed by a processor 308.

Operation of the sensor drivers 304 is controlled through a camera control interface 310 that is in bi-directional communication with the processor 308. Also controlled through the interface 310 are one or more motors 312 that are used to drive the lens system 300 (e.g., to adjust focus and zoom) and, optionally, an electronic viewfinder 314 and the flat panel display 126. Operation of the camera may be adjusted through manipulation of the user interface 316, which communicates to the processor 308 through the camera control interface 310. The user interface 316 comprises the various components used to enter selections and commands into the camera 100 and therefore at least includes the shutter-release button 112, the ring control 114, and the control buttons 128 identified in FIG. 2. Therefore, this user interface 316 may be used to place the camera 100 into a panoramic mode.

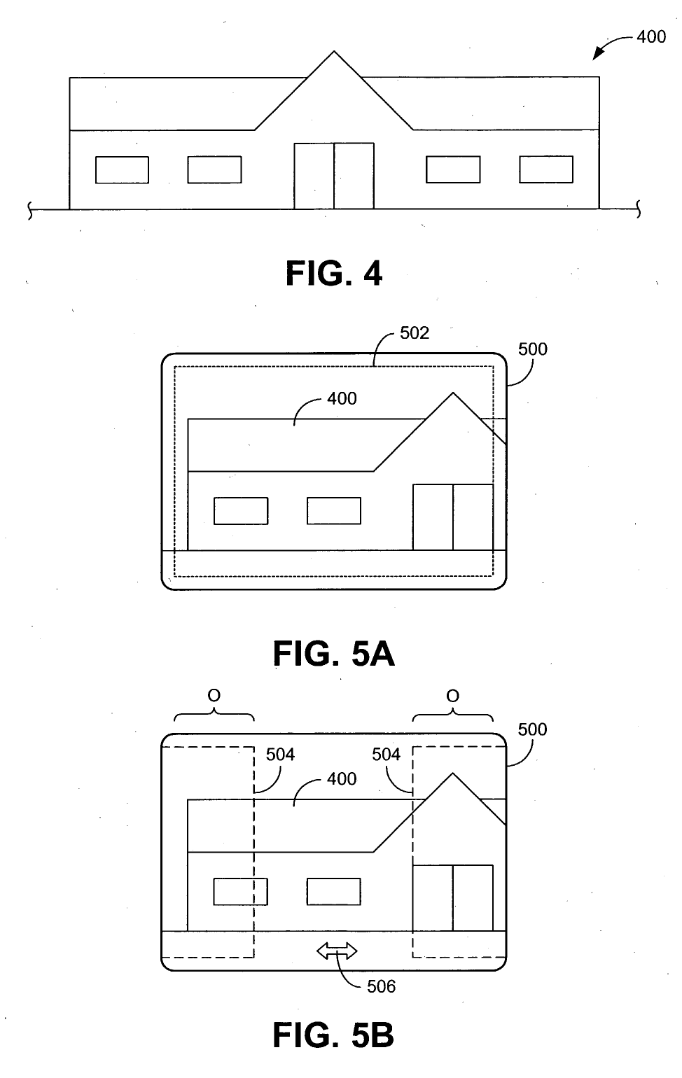

The digital image signals are processed in accordance with instructions from the camera control interface 310 and the image processing system 318 stored in permanent (non-volatile) device memory 320. Processed images may then be stored in storage memory 322, such as that contained within a removable solid-state memory card (e.g., Flash memory card). In addition to the image processing system 318, the device memory 320 further comprises a panoramic sequence guide system 324 (in software or firmware) that is used to generate one or more user interfaces that aid the user in composing and capturing images that are to be joined to create a composite panoramic image. Operation of this system 324 is discussed in greater detail with reference with FIGS. 4-11. In addition to the image processing system 318 and the panoramic sequence guide system 324, the memory 320 includes a dynamic tracking system 326 that facilitates tracking of viewed scenes for the purpose of facilitating the generation and display of composition guides by the panoramic sequence guide system 324, which provides guidance to the user in capturing images in panoramic mode.

The camera 100 also comprises a device interface 328, such as a universal serial bus (USB) connector, that is used to download images from the camera to another device such as a personal computer (PC) or a printer, and which can likewise be used to upload images or other information.

With the provision of the panoramic sequence guide system 324, the user can be guided as to how to compose and capture images that ultimately will be joined to form a composite panoramic image. In the following discussions, several different methods for guiding the user are described. In a first method described in relation to FIGS. 4-5E and FIG. 6, composition guides are provided to the user that identify the next shot to be captured in the image sequence. These guides are superimposed with the viewed scene on the live-view screen to indicate exactly what portion of the scene should be captured next for the purpose of creating a panoramic image. These guides are “fixed” to the scene such that, once the position of the guide relative to the viewed scene has been determined, the guide will “move” with the scene in the live-view screen when the camera is panned, thereby removing the guesswork from the image composing and capturing process. The camera therefore identifies exactly where to point the camera and what portion of the scene to capture.

To facilitate fixing of a composition guide relative to the subject scene, the scene is tracked real time by the dynamic tracking system 326 from a point in time immediately following capture of the first image of panoramic sequence until the time when the user indicates that the last image of the sequence has been captured or the camera is switched out of the panoramic mode. During tracking, relatively low resolution images of the viewed scene are captured in rapid succession and compared to determine the “movement” of objects in the scene relative to the camera orientation. Therefore, as the user pans the camera after capturing the first image of the sequence, the camera tracks the objects identified in the scene as they move across the live-view screen to determine in which direction they are moving and the distance they travel.

Several different methods can be used to track objects in a viewed scene. In one such method, a marker is positioned over a viewed (and captured) image (e.g., in the center of the live-view screen) and X and Y coordinates of this position are recorded. As subsequent images are captured during the tracking process, correlation computations are performed by the dynamic tracking system 326 to determine the change in direction and distance of the current captured image verses the previously captured image. Once the direction and distance of movement between the images are known, a new marker having different X and Y coordinates is determined. This new coordinate value is the new location of the original object in the current image. The object marker is then moved to the new coordinate position.

The above-described process continues as to each new image captured during tracking. The resulting effect is that the marker tracks the original object of the image in which it was positioned. Even if the marker, and therefore the object, “moves” off of the live-view screen, the object's X and Y coordinates can still be tracked in that new objects are identified and tracked in the same manner. In other words, relationships (e.g., distance and direction) between tracked objects are known and therefore may be used such that a scene several screens-widths away from the current viewed scene can still be tracked as the camera is panned. When an object that moved off the screen comes back into the live-view image area, its marker can then be re-enabled over the object.

The aforementioned tracking method is similar in practice to the tracking method described in U.S. Pat. No. 5,644,139, which is hereby incorporated by reference into the present disclosure in its entirety. Although the method described in that patent is implemented in handheld scanning devices, it is analogous to the present tracking method in that identified objects are tracked by correlating their positions across multiple images during movement of the capture device. Instead of objects on a page, however, the objects of the viewed scene are tracked.

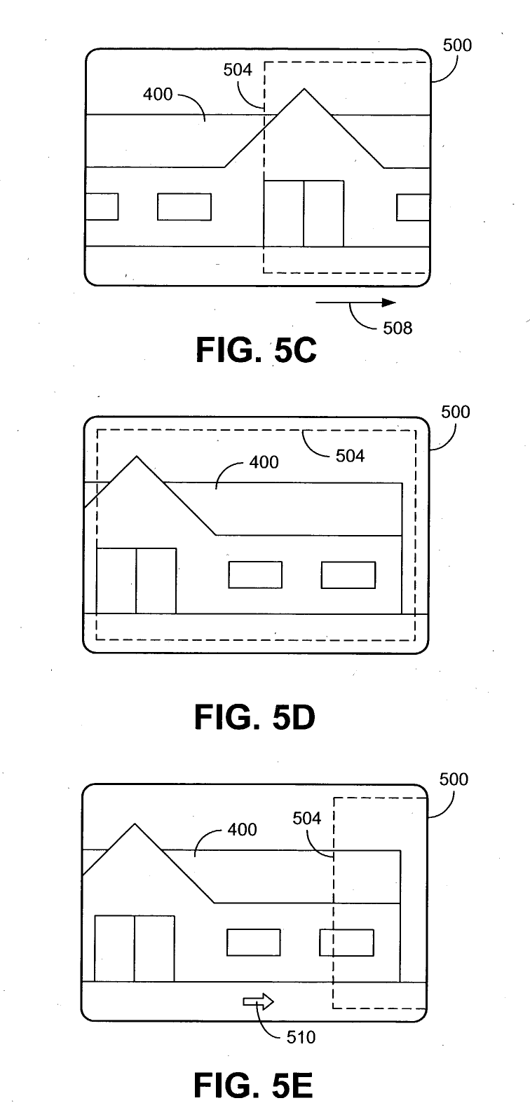

With reference to FIG. 4, illustrated is an example subject 400 that is to be captured and for which digital images are to be joined to form a composite panoramic image. For purposes of example, the subject 400, a long building, is assumed to be approximately two live-view screen widths in length at a zoom setting that is going to be used to capture the subject. FIGS. 5A-5E depict a first method for guiding the user in composing and capturing images for the purpose of creating a panoramic image. In these figures, it is assumed that the camera has been set to a panoramic mode by the user, for instance by manipulating the user interface 316 (e.g., buttons 128, FIG.2).

Beginning with FIG. 5A, the user composes the first image of the panoramic sequence to be captured by manipulating the camera orientation and zoom such that a portion of the subject 400 is viewed in the live-view screen 500. By way of example, the portion of the subject 400 is an end portion of the subject, in this case, the left-most end of the building. With this composition, a portion of the viewed scene will be captured. Typically, this portion will be less than the entire scene viewed in the live-view screen 500. This portion may, for instance, comprise the portion of the scene within box 502. Although this box 502 is illustrated in FIG. 5A merely to identify to the reader the portion of the viewed scene that can be captured, the box can actually be shown to the user on the live-view screen 500, if desired, as an indication of what he or she is about to capture.

Once the first image of the sequence has been composed, the user captures the image by depressing the shutter-release button (112, FIG. 1). At this point, the tracking process described above begins and the dynamic tracking system 326 begins identifying objects and tracking their movements by comparing rapidly collected images. In addition, various settings of the camera may be locked at this time. For instance, in order to maintain continuity between the first captured image and those to follow, the focus, exposure, white balance, and zoom settings may all be locked until the user indicates the final image has been captured or switches the camera out of the panoramic mode. Optionally, the captured image is stored in memory 322 (FIG. 3) along with metadata that identifies that the image is the first captured in a given sequence of images to be joined in a panoramic image. Furthermore, coordinates (e.g., X and Y coordinates) may be stored along with the image to aid in the joining process when the panoramic image is created.

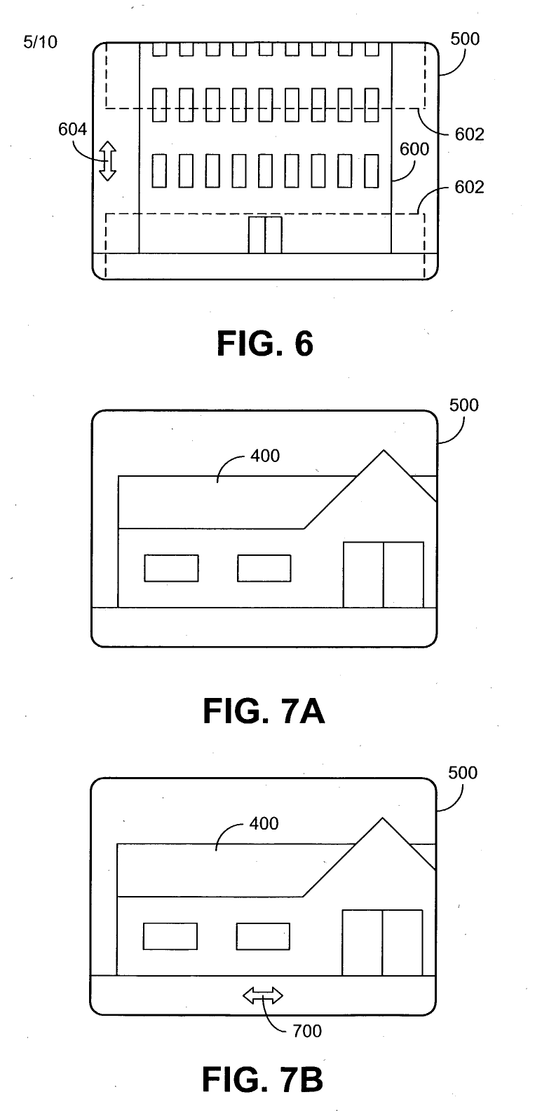

Substantially simultaneous to the initiation of tracking and locking of camera settings, a user interface comprising at least one composition guide 504 is displayed in the live-view screen 500. As indicated in FIG. 5B, two composition guides 504 can be displayed, one positioned at each side of the live-view screen 500. Alternatively, just one of these two guides 504 may be displayed. In either case, the camera is then prepared to capture a sequence of images in a horizontal sequence. A horizontal sequence may have been enabled by default, or may have been selected by the user. In a further alternative, a vertical sequence of images may be captured in which case one or more composition guides are provided at the top and bottom of the live-view screen 500 (see FIG. 6). Vertical panoramic image capture guidance may be enabled by default or by user selection along with, or in exception to, the horizontal panoramic image capture guidance. Alternatively, the direction of movement (i.e., panning) of the camera can be detected by the tracking system to identify what type of panoramic image is to be captured. Where both vertical and horizontal image capture guidance are provided at the same time, however, confusion may arise due to overlap of vertical and horizontal composition guides. Therefore, for purposes of this discussion, horizontal image capture guidance alone using two composition guides is assumed.

With further reference to FIG. 5B, the composition guides 504 are formed as rectangles that typically are of equal or similar size to the size of images that are captured with the camera. Therefore, the composition guides 504 are normally about the size of the box 502 shown in FIG. 5A. It is noted, however, that other sizes generally indicative of the next shot to be captured may be used. In that these composition guides 504 indicate (e.g., outline) the portion of the subject 400 that is to be captured next, only a portion of each box 502 is visible in the live-view screen 500 if the user has not yet moved the camera from the originally captured scene. Preferably, the composition guides 504 are positioned such that the composition guides overlie a portion, for example about ¼ to about ⅓, of the previously captured scene. In such a case, a significant amount of image overlap O is provided assuming the user captures the next image as suggested by a composition guide 504.

Assuming, as in FIG. 5B, that two composition guides 504 are provided, an indicator 506 in the form of a double-sided arrow may be used to communicate to the user that the camera may be panned either right or left, depending upon what panoramic image is desired. Assuming that the user pans the camera to the right, as indicated by arrow 508 in FIG. 5C, the live-view screen 500 scans over the subject 400. As is apparent from FIG. 5C, as the camera is panned right, the viewed subject 400 “moves” across the screen 500 to the left as expected. In addition, however, through implementation of the object tracking described above and due to the fact that the composition guides 504 are “fixed” to the scene, at least one composition guide 504 moves left with the subject 400. Optionally, the left-side composition guide 504 (FIG. 5B) is dropped from the live-view screen 500, as indicated in FIG. 5C, once rightward panning is detected by the dynamic tracking system 326. Alternatively, however, both guides 504 may remain, thereby providing the user with the ability to expand the panoramic image to the left beyond the boundary of the first captured image (FIG. 5A), if desired.

Through the user's continued panning, the composition guide 504 eventually aligns with the live-view screen 500 as indicated in FIG. 5D. It is when the composition guide 504 is so aligned (i.e., centered) that the next image may be captured. This condition may be signaled to the user by the composition guide 504 changing color (e.g., from white to green), or increasing in size or brightness, or by the camera emitting an audible indicator (e.g., a beep) from the camera speaker (130, FIG. 2). Regardless, the user may then depress the shutter-release button (112, FIG. 1) to capture the second image in the panoramic sequence.

At this point, the camera is prepared to capture the next image in the panoramic sequence and therefore displays a composition guide 504 that is indicative of the composition of the third image, as shown in FIG. 5E. In that the user had chosen to pan to the right, only one composition guide 504 is provided, and it is positioned on the right side of the live-view screen 500. In addition, an indictor 510 can be displayed that instructs the user to pan right, if another image is to be captured. In this example, however, two images are enough to create the panoramic image of the subject 400 and, therefore, the user may indicate (e.g., by pressing an appropriate button) that the last image of the sequence has been captured, or may simply switch the camera out of the panoramic mode.

FIG. 6 provides an example of the first guidance method as used to aid the user in composing and capturing images of a vertical subject 600, in this example a tall building. As indicated in this figure, after a first image of the subject 600 is captured, vertical composition guides 602 for the subsequent image to be captured are provided at the top and bottom of the live-view screen 500. Additionally, an indicator 604 in the form of a double-sided arrow can be displayed to communicate to the user that the user may then pan up or down, depending upon the scene that is to be captured.

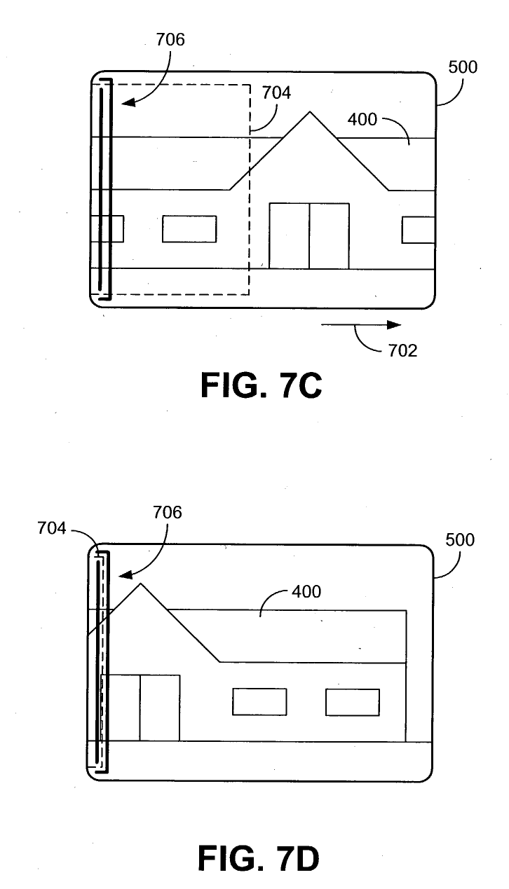

FIGS. 7A-7D depict a second method for guiding a user in composing and capturing images for the purpose of creating a panoramic image. Beginning with FIG. 7A, the user composes the first image of the panoramic sequence in similar manner to that described above with reference to FIG. 5A. Once the first image of the panoramic sequence has been composed, the user captures the image by depressing the shutter-release button (112, FIG. 1). As in the first guidance method, the dynamic tracking system 326 then begins tracking objects in the viewed scene, various settings of the camera are locked, and metadata associated with the captured image is stored.

In the second guidance method, composition guides are not initially displayed. However, an indicator 700 such as a double-sided arrow may be displayed as shown in FIG. 7B to communicate to the user that the camera may be panned either right or left. Assuming again that the user pans the camera to the right, as indicated by arrow 702 in FIG. 7C, the viewed subject 400 “moves” across the screen 500 to the left. The panning of the camera also causes a composition guide 704 to appear in the live-view screen 500. As the composition guides 504 described above, the composition guide 704 is fixed to the viewed scene. However, in this case, the composition guide 704 represents the previously captured image instead of the next image that is to be captured. Although, the composition guide 704 may be positioned so as to precisely define-the outline of the previously captured image, more preferably the composition guide is positioned so as to be offset to facilitate overlapping of captured images. For example, this offset can comprise about ¼ to about ⅓ of the width of the originally captured scene.

Optionally, a stationary (with respect to the live-view screen 500) alignment guide 706 may also be displayed in the live-view screen 500 to aid the user in composing the next shot. As indicated in FIG. 7C, the alignment guide 706 can, for instance, comprise two parallel vertical lines placed at the edge of the live-view screen 500. After continued panning, the right-most vertical side of the composition guide 704 will align with the alignment guide 706. For instance, where the alignment guide comprises a two vertical lines, a right-most vertical side of the composition guide 704 may be centered between the vertical lines as indicated in FIG. 7D to indicate correct composition. Again, correct composition may be visually or audibly communicated to the user (e.g., changing colors or brightness, emission of a beep, etc.). When the shot is composed as shown in FIG. 7D, the camera can be controlled to capture an image that overlaps the previous captured scene to an extent that facilitates later joining of the images.

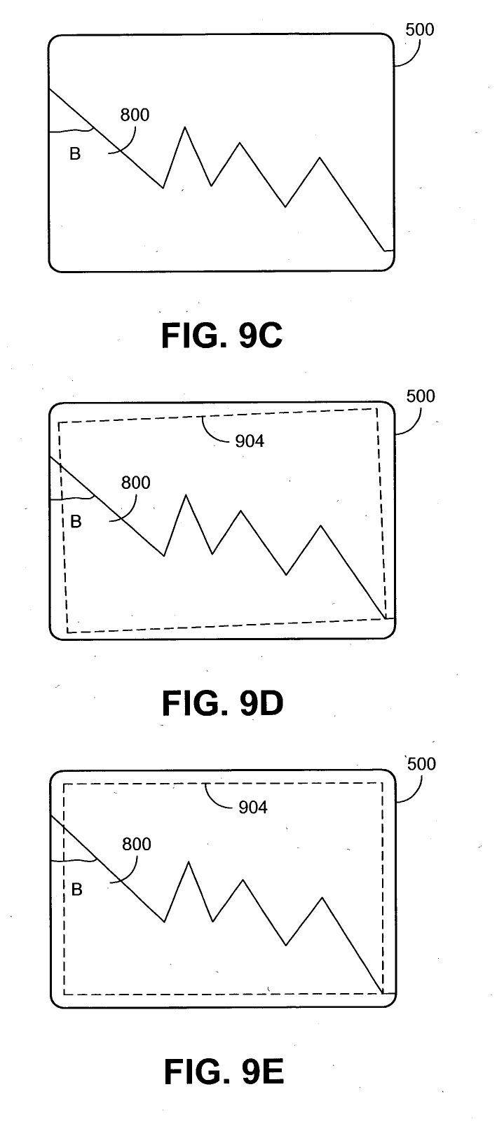

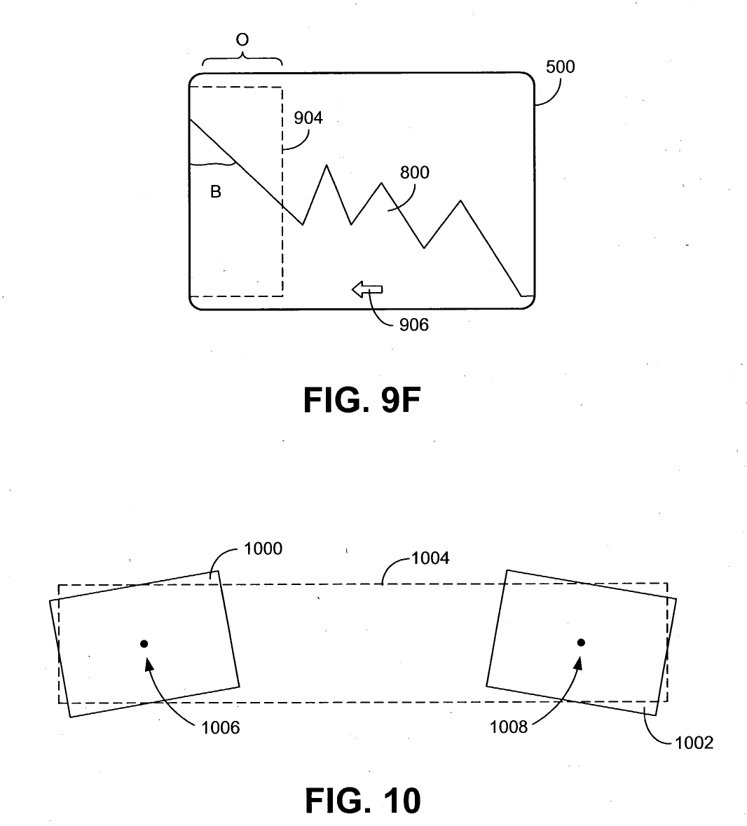

In a third guidance method, the end points of a panoramic scene are selected by the user and the camera then determines what images should be captured to obtain a panoramic image defined by the end points. An example of this technique is described in relation to FIGS. 9A-9F. As will be apparent from the discussion that follows, this method is especially useful when a relatively long panoramic image, or even a 360° view, is to be created in that the technique can be used to avoid capture of a sequence of images that are out of alignment relative to the viewed scene. Such a result can occur when the first captured image was not correctly aligned with the scene (e.g., not perfectly level). If the remainder of the shots are aligned relative to that first captured image, the error may become more apparent, particularly where many images are used to compose the panoramic image.

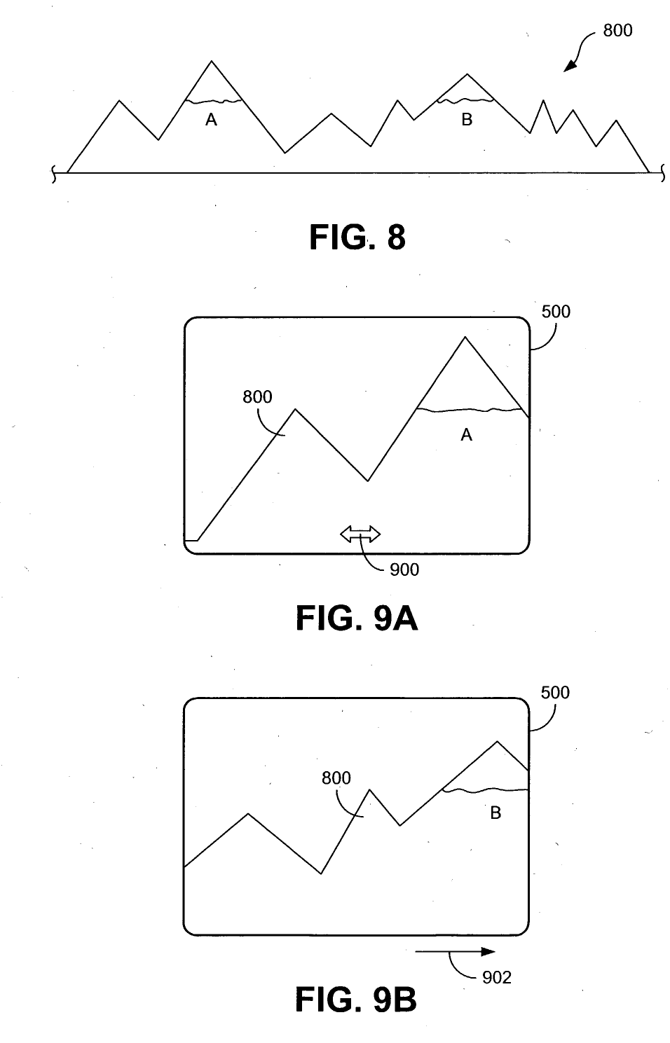

Referring to FIG. 8, illustrated is a relatively long subject 800 that is to be captured. For purposes of example, the subject 800, a mountain range, is assumed to be approximately four or five live-view screen widths in length at a zoom setting that is going to be used to capture the subject. Two peaks of the mountain range are labeled “A” and “B” to simplify their identification in FIGS. 9A-9F.

With reference to FIG. 9A, the user composes the first image of the panoramic sequence to be captured by manipulating the camera orientation and zoom such that a portion of the subject 800 is viewed in the live-view screen 500. For this example, the portion of the subject 800 is the left-most end of the mountain range. Once the first image of the sequence has been composed, the user then designates or “sets” the image as the first end point of the panoramic image to be created. By way of example, this can be accomplished by selecting a button on the camera that is associated with this functionality, or by pressing the shutter-release button half-way when the camera is in the appropriate panoramic mode. Although an image could optionally be captured and stored simultaneous with the setting process, preferably no such image is stored to permit for correction of misalignment, as is discussed in greater detail below.

At this point, the tracking process begins, various settings of the camera are locked, and appropriate metadata is stored. As in the second guidance method described above in relation to FIG. 7A, composition guides are not shown initially but an indicator 900 may be displayed to indicate that the camera may be panned either right or left. Assuming that the user pans the camera to the right, as indicated by arrow 902 in FIG. 9B, the viewed subject 800 “moves” across the live-view screen 500 and is tracked by the dynamic tracking system 326. Once the opposite end of the scene to be captured has been reached (FIG. 9C), the user can then set the viewed image as the second end point of the panoramic image to be created. Again, this can be accomplished by selecting a given button or by depressing the shutter-release button halfway. Optionally, the average of the focus, exposure, and white balance settings obtained at the first and second end points, respectively, can be used as the settings for capturing the sequential images that will be used to generate the composite panoramic image.

Next the camera displays a composition guide 904 that is indicative of the composition of the first and second image to be captured, as shown in FIG. 9D. Having identified the coordinates of the first and second ends of the panoramic image, the panoramic sequence guide system 324 displays a composition guide 904 that is horizontally aligned so as to properly capture the panoramic image that it has determined should be captured. Therefore, when the camera is out of alignment with respect to this horizontal orientation, as in FIG. 9D, the composition guide 904 will appear skewed relative to the live-view screen 500. This phenomenon is illustrated in FIG. 10. As shown in this figure, if a first end image 1000 is skewed relative to a second end image 1002, the panoramic sequence guide system 324, with aid from the dynamic tracking system 326, determines the correct placement of the composition guides 904 such that they align with a virtual panoramic image 1004 that is properly aligned between the two end points. The position of the virtual panoramic image 1004 can be simply determined,by defining a rectangular area representative of the panoramic image to be captured that extends between and encompasses the first end point, e.g., identified by its center point 1006, and the second end point, e.g., identified by its center point 1008. Therefore, misalignment from user error will not adversely affect the resultant panoramic image.

Due to the skewed orientation of the composition guide 904 in FIG. 9D, the user is notified of the misalignment and provided with an indication as to how to correct it. Therefore, the user can reorient the camera such that the live-view screen 500 is aligned parallel to the composition guide 904 as indicated in FIG. 9E.

Once the scene is correctly composed, the shutter-release button (112, FIG. 1) can be fully depressed so that the first image (at the second end of the panoramic) is captured. Next, a new composition guide 904 that indicates the location of the next image in the panoramic sequence to be captured and a directional indicator 906 are displayed, as indicated in FIG. 9F. Operation then continues in the described above manner until the last image (at the first end of the panoramic scene) is captured.

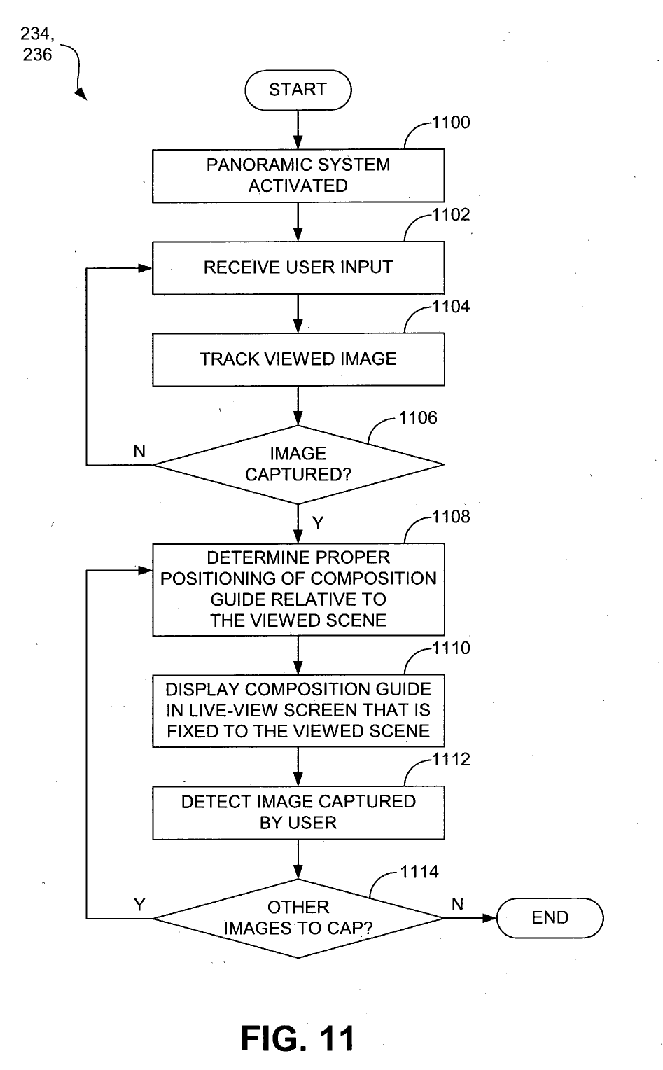

FIG. 11 summarizes the operation of the panoramic sequence guide system 324 and the dynamic tracking system 326 in aiding a user in composing and capturing images that are to be joined to create a panoramic image. For purposes of convenience, the panoramic sequence guide system 234 and the dynamic tracking system 326 are referred to as the panoramic system. In the flow diagram of FIG. 11, process steps or blocks may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

Beginning with block 1100, the panoramic system is activated. Typically, this activation occurs when the user selects the appropriate panoramic mode on the camera. Next, some form of user input is received by the system, as indicated in block 1102. The input received may depend upon the particular guidance method that is being used. For instance, in the first and second guidance methods, the user action may comprise the user composing and capturing the first image of the panoramic sequence. In the third guidance method, the action may comprise setting the first end point of the panoramic sequence.

Next, with reference to block 1104, the viewed image is tracked in the manner described above. At this point, flow may depend upon whether an image was captured by the user (see decision block 1106). If not, the user input in block 1102 may have been the user setting the first end point in which case flow returns to block 1102 so that the second end point may be set. If, on the other hand, an image was captured, flow continues to block 1108 at which the system determines the proper positioning of at least one composition guide relative to the viewed scene. As identified in the foregoing, this step requires accurate tracking of the viewed scene and its associated computations. Once this determination has been made, at least one composition guide is displayed in the live-view screen, as identified in block 1110. As described above in relation to each guidance method, the composition guide is fixed to the viewed scene such that it will move with the scene as the camera is panned in any direction.

After the user has composed the next shot, the user may depress the shutter-release button and, as indicated in block 1112, the system detects that an image has been captured. Flow from this point depends upon whether that captured image was the last in the panoramic sequence or whether other images are to be captured. With reference to decision block 1114, if other images are to be captured, flow returns to block 1108 and the positioning of at least one new composition guide is determined. If, however, the captured image was the last of the panoramic sequence (as indicated by the user), flow for the capture session (at least as to this panoramic) is terminated.

While particular embodiments of the invention have been disclosed in detail in the foregoing description and drawings for purposes of example, it will be understood by those skilled in the art that variations and modifications thereof can be made without departing from the scope of the invention as set forth in the claims.

Various programs, in software and/or firmware, have been identified above. These programs can be stored on any computer-readable medium for use by or in connection with any computer-related system or method. In the context of this document, a computer-readable medium is an electronic, magnetic, optical, or other physical device or means that can contain or store programs for use by or in connection with a computer-related system or method. The programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. The term “computer-readable medium” encompasses any means that can store, communicate, propagate, or transport the code for use by or in connection with the instruction execution system, apparatus, or device.

What is claimed is:

1. A method for guiding a user in composing and capturing images to be used to create a composite panoramic image, comprising:
tracking a viewed scene;
determining the proper position of a composition guide relative to the viewed scene; and
displaying a composition guide on a live-view screen that provides an indication of what portion of the viewed scene is to be captured, the composition guide being fixed to the viewed scene such that the guide moves with the viewed scene in the screen.

2. The method of claim 1, wherein tracking a viewed scene comprises positioning a marker over a viewed scene, recording coordinates of its position, and performing correlation computations to determine the change in direction and distance of a presently viewed scene verses a previously viewed scene.

3. The method of claim 1, wherein determining the proper position of a composition guide comprises determining the location of a scene that was previously captured and determining the position for the guide relative to that scene.

4. The method of claim 1, wherein determining the proper position of a composition guide comprises determining the location of a scene that is to be captured and determining the position for the guide relative to that scene.

5. The method of claim 1, wherein displaying a composition guide comprises displaying a guide that is indicative of a previously captured scene.

6. The method of claim 1, wherein displaying a composition guide comprises displaying a guide that is indicative of a scene that is to be captured.

7. The method of claim 1, wherein displaying a composition guide comprises displaying a rectangle indicative of one of a previously captured image and an image that is to be captured.

8. The method of claim 7, wherein displaying a composition guide further comprises displaying the guide such that it is offset relative to the previously captured image or image to be captured, so as to facilitate overlapping of images.

9. The method of claim 1, further comprising receiving selection of first and second endpoints and determining a virtual panoramic image to be captured that extends between the endpoints.

10. The method of claim 9, wherein displaying a composition guide comprises displaying a composition guide that is aligned with and forms part of the virtual panoramic image.

11. A system for guiding a user in composing and capturing images to be used to create a composite panoramic image, comprising:
a dynamic tracking system that is configured to track a viewed scene such that objects in the scene are identified and their movement tracked relative to a live-view screen; and
a panoramic sequence guide system that is configured to receive information from the tracking system, determine the proper placement of a composition guide relative to the viewed scene, and display a composition guide on the live-view screen to provide a user with an indication of what portion of the viewed scene is to be captured next in a sequence of scenes in order to capture images that can be used to create the panoramic image, the composition guide being fixed relative to the viewed scene in the live-view screen such that the guide moves with the viewed scene.

12. The system of claim 11, wherein the dynamic tracking system is configured to position a marker over a viewed scene, record coordinates of its position, and perform correlation computations to determine the change in direction and distance of a presently viewed scene verses a previously viewed scene.

13. The system of claim 11, wherein the panoramic sequence guide system is configured to determine the proper position of the composition guide relative to a previously captured image.

14. The system of claim 11, wherein the panoramic sequence guide system is configured to determine the proper position of a composition guide relative to a scene to be captured.

15. The system of claim 11, wherein the panoramic sequence guide system is configured to display a rectangle that is indicative of an image that was or is to be captured.

16. The system of claim 11, wherein the panoramic sequence guide system is configured to display a composition guide that is offset relative to the image that was or is to be captured.

17. The system of claim 11, wherein the panoramic sequence guide system is further configured to receive selection of first and second endpoints indicative of first and second ends of a panoramic scene and to determine a panoramic image that is to be captured.

18. A guidance system stored on a computer-readable medium, comprising:
logic configured to track objects of a viewed scene by determining their coordinates; and
logic configured to display at least one composition guide on a live-view screen that is fixed to the viewed scene so as to move across the screen along with the viewed scene, the at least one composition guide providing an indication of what portion of the viewed scene is to be captured next in order to create a panoramic image.

19. The system of claim 18, wherein the logic configured to display is configured to display a composition guide indicative of a previously captured image.

20. The system of claim 18, wherein logic configured to display is configured to display a composition guide indicative of a scene that is to be captured next.

21. A panoramic image guidance system, comprising:
means for tracking a scene viewable in a live-view screen; and
means for displaying a composition guide on the live-view screen, the guide being associated with the viewable scene so as to move in unison with the scene relative to the screen, the composition guide providing an indication of what portion of the scene is to be captured.

22. The system of claim 21, wherein the means for display is configured to display a rectangle indicative of an image that has been or is to be captured.

23. A camera, comprising:
a live-view screen;
a processor; and
memory comprising a dynamic tracking system and a panoramic sequence guide system, the dynamic tracking system being capable of tracking a scene viewable in the live-view screen so that movement of objects in the scene relative to the screen can be identified, the panoramic sequence guide system being capable of displaying a composition guide on the live-view screen that provides a user with an indication of what portion of the viewed scene to capture, the composition guide being fixed relative to the viewable scene such that the guide moves in unison with the scene.

24. The camera of claim 23, wherein the live-view screen comprises a screen within a camera viewfinder.

25. The camera of claim 23, wherein the live-view screen comprises a back-panel display of the camera.

26. The camera of claim 23, wherein the panoramic sequence guide system is configured to display a composition guide that is indicative of a previously captured image.

27. The camera of claim 23, wherein the panoramic sequence guide system is configured to display a composition guide that is indicative of an image that is to be captured.
